(19) United States
(12) Patent Application Publication
(10) Pub. No.: US 2025/0041954 A1
(43) Pub. Date: Feb. 6, 2025

(54) ADJUSTABLE SHOE FOR A POWER TOOL

(71) Applicant: Harbor Freight Tools USA, Inc., Calabasas, CA (US)

(72) Inventor: Jon Howell, Agoura Hills, CA (US)

(21) Appl. No.: 18/230,481

(22) Filed: Aug. 4, 2023

(51) Int. Cl. B23D 59/00

(52) U.S. Cl. CPC B23D 59/00; B23D 53/12; B23D 55/00

(57) ABSTRACT

A shoe positioning system for use with a power tool that operates on a work piece may include a shoe, an indexing member, and an index plunger. The shoe may abut the work piece during operation of the power tool. The indexing member may movably engage with the shoe and may include a plurality of index openings. The index plunger may be coupled to the shoe and it may be movable between a first and second positions. When the index plunger is in the first position, the index plunger may be received by at least one of the index openings, thereby preventing the shoe from substantially moving along a longitudinal dimension with respect to the indexing member. When the index plunger is in the second position, the index plunger may be outside of the index openings, thereby permitting the shoe to move.

### BACKGROUND

The present application discloses an adjustable shoe for a power tool. Such a power tool can be a band saw (for example, a handheld band saw). The power tool operates on an object (i.e., a work piece, such as a board, rod, pipe, tubing, or the like). The band saw can include or be attached to a shoe (or foot). Such a shoe functions as a work stop or material guide for the work piece. The shoe can further facilitate locating, stabilizing, or positioning the power tool against the work piece.

### SUMMARY

According to embodiments of the present invention, a shoe positioning system for use with a power tool that operates on a work piece is described. It includes a shoe, an indexing member, and an index plunger. The shoe is configured to abut the work piece when the power tool operates on the work piece. The indexing member movably engages with the shoe (for example, the shoe can have a slot that receives the indexing member). The indexing member can be mounted on the power tool. The indexing member can include at least one feature that constrains a range of movement of the shoe along a longitudinal dimension. The indexing member can also include at least one feature configured to constrain a range of movement of the index plunger along its axial axis. The indexing member can also include a plurality of elevated portions separating a plurality of index openings.

The index plunger can be coupled to the shoe and includes an engagement portion. The engagement portion receives an engagement force to move the index plunger in a first direction along the index plunger's axial axis. When the engagement force is not received by the index plunger, the engagement portion is disposed in a first position. In the first position, the engagement portion of the index plunger can be received by at least one of the index openings, thereby preventing the shoe from substantially moving along a longitudinal dimension (a dimension substantially orthogonal to the axial axis) with respect to the indexing member. When the engagement force is received by the index plunger, the engagement portion is moved to a second position. In the second position, the engagement portion of the index plunger is outside of the index openings, thereby permitting the shoe to move along the longitudinal dimension with respect to the indexing member. The index openings are spaced apart from each other along the longitudinal dimension.

The system can further include a spring that biases the index plunger in a second direction opposite the first direction along the axial axis of the index plunger. The spring can substantially surround an axial portion of the index plunger. The spring maintains the index plunger in the first position when the engagement force is not received by the index plunger, and it returns the index plunger to the first position when the index plunger is in the second position and the engagement force is removed from the index plunger.

According to embodiments of the present invention, a shoe positioning system for use with a power tool that operates on a work piece includes: a shoe, an indexing member, and an index plunger. The shoe is configured to abut the work piece when the power tool is operating on the work piece. The indexing member includes a base region and a plurality of elevated portions extending upwardly to a maximum elevation above the base region. The plurality of elevated portions are separated by a plurality of index openings that do not extend up to the maximum elevation above the base region. The indexing member can be mounted to the power tool. The shoe moves along a longitudinal dimension with respect to the indexing member. The shoe can include a slot to receive the indexing member. The indexing member includes one or more features that constrain the range of movement of the shoe along the longitudinal dimension.

The index plunger can be coupled to the shoe. The index plunger includes a transverse portion having a lowest elevation that is maintained at an elevation above the elevated portions of the indexing member. The index plunger includes an engagement portion extending downwardly from the transverse portion towards the base region of the indexing member. The index plunger is configured to move along its axial axis. The index plunger is movable to a first position and a second position with respect to the indexing member. When the index plunger is in the first position, at least a portion of the engagement portion is positioned in one of the index openings of the indexing member, thereby preventing substantial movement of the shoe along its longitudinal dimension (for example, the longitudinal dimension may be substantially orthogonal to the axial axis) with respect to the indexing member. When the index plunger is in the second position, the engagement portion is positioned outside the index openings of the indexing member, thereby permitting movement of the shoe with respect to the indexing member along its longitudinal dimension, such that at least a portion of at least one elevated portion passes under the transverse portion of the index plunger as the shoe moves. Two or more of the index openings are spaced apart from each other along the longitudinal dimension. The indexing member can include at least one feature that constrains a range of movement of the index plunger along its axial axis.

The system can further include a spring that biases the index plunger towards the first position. The spring can substantially surround a portion of the index plunger. The spring maintains the index plunger in the first position when the engagement force is not received by the index plunger. The spring returns the index plunger to the first position when the index plunger is in the second position and the engagement force is removed from the index plunger.

### BRIEF DESCRIPTION OF SEVERAL VIEWS OF THE DRAWINGS

FIGS. 1A and 1B depict a band saw with an adjustable shoe system having the shoe in a first position and a second position, respectively, according to techniques of the present application.

FIGS. 2A, 2B, and 2C show perspective, exploded, and cross-sectional views of an adjustable shoe system, respectively, according to techniques of the present application.

FIGS. 3A and 3B illustrate a portion of an adjustable shoe system in a locked and unlocked arrangement, respectively, according to techniques of the present application.

FIGS. 4A, 4B, 4C, and 4D show representational depictions of operations of an adjustable shoe system, according to techniques of the present application.

FIG. 5 illustrates a cross-sectional view of a portion of an adjustable shoe system, according to techniques of the present application.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

The present invention relates to an adjustable shoe system for use with a power tool. Such power tools can include band saws, reciprocating saws, circular saws, or jig saws. The techniques described herein often refer to using the adjustable shoe system with a band saw, but the inventive principles may be applicable to other power tools. A band saw (for example, a handheld band saw) includes a looped blade. The band saw also include a shoe to locate a work piece with respect to a cutting portion of the band saw blade. To make various types of cuts or to accommodate different work pieces, it can be useful for the shoe to be adjustable with respect to the band saw. For example, an adjustable shoe can be useful to minimize or reduce the length of the shoe during operation to only what is needed for a particular task. In cases where a non-adjustable shoe would limit the downward travel of the saw, the adjustable shoe can be adjusted to only approximately the length that is needed (and no more).

Generally, the shoe allows the operator to rest the tool against the work piece being cut. For larger pieces, the shoe may need to rest farther down the work piece in order to stabilize the saw while cutting. The shoe also provides a leverage point against the direction of cut for faster cutting. Without a longer shoe, the saw can be relatively easy to twist in the operator's hands, thereby making a poor quality or uneven cut. Such undesirable twisting or binding can also lead to blade breakage. Being able to adjustably move the shoe can mitigate these issues. For smaller work pieces, the operator can shorten the adjustable shoe such that interference from objects aside from the work piece can be minimized or reduced.

According to embodiments of the present invention, an adjustable shoe or foot can stabilize or position a power tool (for example, a handheld band saw) against a work piece. The shoe is repositioned relative to the power tool by applying a force to an actuator (for example, a button) to disengage an index plunger from an indexing member. Once disengaged, the shoe is movable along a longitudinal dimension with respect to the indexing member. Once the position of the shoe has been adjusted, the index plunger reengages with the indexing member, thereby substantially preventing motion of the shoe along the longitudinal dimension.

The adjustable shoe includes the shoe and an indexing member. The shoe may be adjacent to a work opening. The indexing member can be mounted to the power tool (for example, to the housing of the power tool) by one or more connectors (for example, bolts). The shoe moves relative to the indexing member and the power tool. The shoe can have a slot that receives the indexing member. This can allow the shoe to move along the longitudinal dimension while being constrained from substantial motion in at least some other dimensions.

The position of the shoe is adjustable to two or more predetermined positions with respect to the power tool. According to certain embodiments described herein, this is accomplished by providing a plurality of elevated portions (for example, four portions) on the indexing member that are separated by a plurality of index openings (for example, three openings). Each index opening corresponds to a different predetermined position of the adjustable shoe. The index openings can be slightly wider than an engagement portion of the index plunger. To substantially secure the position of the shoe to a given predetermined position along the longitudinal dimension, the engagement portion is received by a given index opening. To move the shoe to a different position, the engagement portion of the index plunger is removed from a given index opening, thereby allowing the shoe to move with respect to the indexing member. Once the shoe is in a different predetermined position, the engagement portion is received by a different index opening, thereby substantially securing the shoe in the new position.

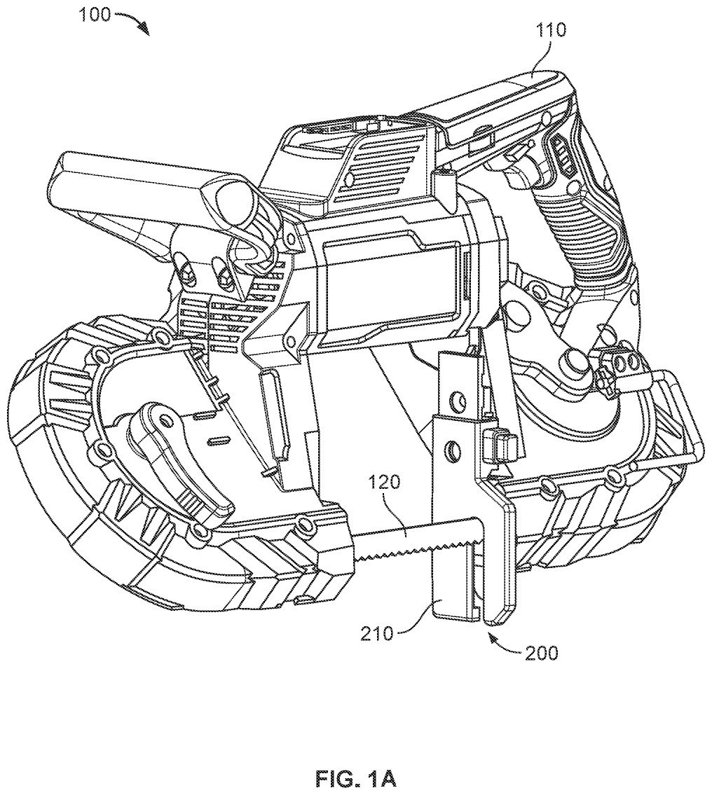

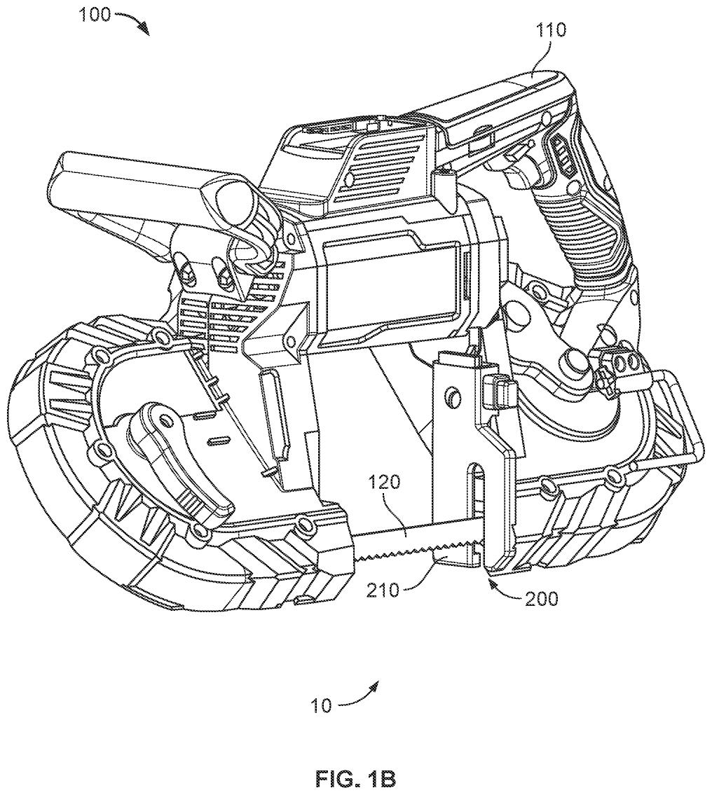

FIGS. 1A and 1B depict a system including a band saw 100 with an adjustable shoe system 200 having the shoe 210 in a first position and a second position, respectively, according embodiments of the present invention. The band saw 100 can be a hand-held device. The band saw 100 includes a housing 110 and a blade 120. The band saw 100 is used to operate on a work piece (not shown), for example, a board, rod, pipe, tubing, or the like. When operating the band saw 100, the operator positions or stabilizes the band saw 100 against the work piece that is being cut by the blade 120. It can be advantageous for the operator to reposition the shoe 210 for different cutting applications—for example, cutting a pipe resting on a surface (e.g., the floor or workbench) versus cutting a freestanding pipe. For example, it can be preferable in some instances to have the shoe 210 in a first position such that the blade 120 is positioned relatively deep within a recess of the shoe 210. Positioning the shoe 210 in the first position can facilitate band saw 100 operations such as cutting a relatively large pipe. When the blade 120 is positioned relatively deeply within the recess of the shoe 210, the operator can be able to apply more leverage with the shoe 210 against the work piece to facilitate a more stable cutting operation. As another example, it could preferable to have the shoe 210 in a second position such that the blade 120 is positioned relatively shallowly within a recess of the shoe 210. Positioning the shoe 210 in the second position can facilitate band saw 100 operations such as cutting a work piece resting on a workbench. When the blade 120 is positioned relatively shallowly within the recess of the shoe 210 (e.g., the cutting edge of the blade 120 is flush with or extends past the bottom of the shoe 210), the shoe 210 may not interfere with an operation of cutting entirely through a work piece that abuts a surface. In such an operation, if the blade 120 is positioned too deeply within the recess of the shoe 210, the bottom of the shoe 210 could contact the abutting surface before the blade 120 cuts completely through the work piece. As further discussed, there could be more than two positions (for example, three) for the shoe 210. Such additional granularity for positioning the shoe 210 can facilitate band saw 100 operations as desired by the operator.

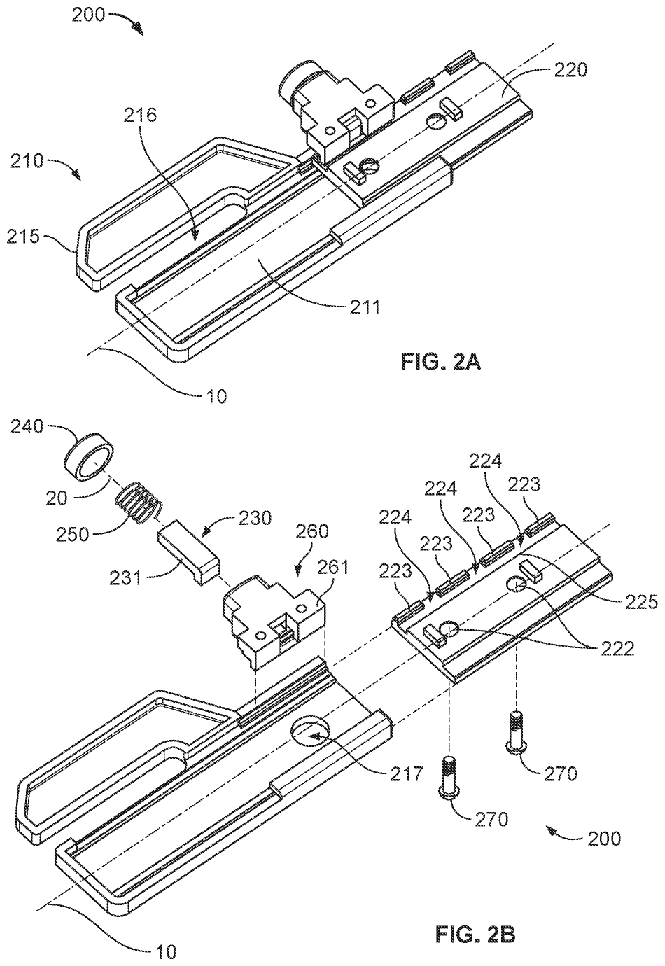

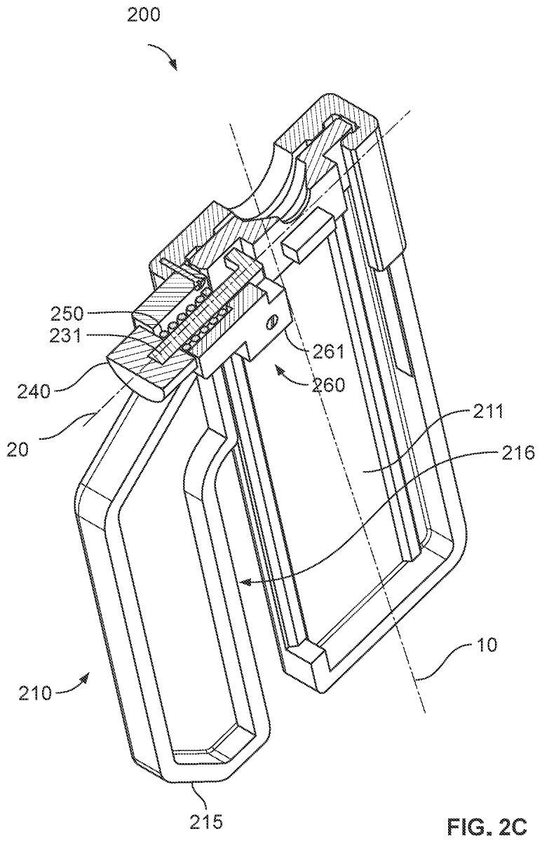

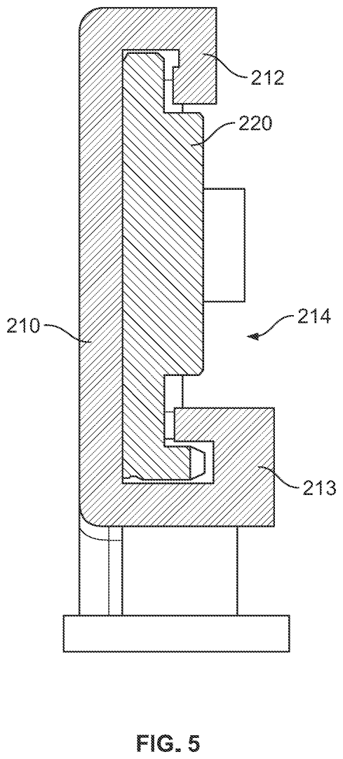

FIGS. 2A, 2B, and 2C show perspective, exploded, and cross-sectional views of an adjustable shoe system 200, respectively, according to embodiments of the present invention. The system 200 includes a shoe 210, an indexing member 220, an index plunger 230, an actuator 240, a spring 250, a coupler 260, and one or more fasteners 270. The shoe 210 includes include a base portion 211 that receives the indexing member 220. As shown in FIG. 5, to facilitate receiving the indexing member 220 in a proper arrangement, the shoe 210 can include features 212, 213 that, together with the base portion 211, form a slot 214 to receive the indexing member 220. The slot 214 allows the shoe 210 to slide with respect to the indexing member 220. The slot 214 constrains the motion of the shoe 210 with respect to the indexing member 220, such that the shoe 210 can only move substantially along a longitudinal dimension (shown by the broken line). The slot can extend from the upper extent (or proximate the upper extent) along the longitudinal dimension 10. The shoe 210 further includes a prong 215, which extends from the base portion 211. The prong 215 together with the base portion 211 form a recess 216, which receives the blade 120. The base portion 211 can further include an aperture 217. The aperture 217 allows access to fasteners 270 to permit the adjustable shoe system 200 to be removed or mounted to the band saw 100. The shoe 210 can include or be formed of a material such as steel or aluminum.

The indexing member 220 engages with the shoe 210, for example, by being received by the slot 214 in the shoe 210 or by another means. The indexing member 220 can move with respect to the shoe 210, for example, along the longitudinal dimension 10. The motion of the indexing member 220 with respect to the shoe 210 may be substantially constrained except for along the longitudinal dimension 10. The indexing member 220 can be secured to the tool 100 (for example, the housing of the tool 100). For example, the indexing member 220 can include a base region 221 with one or more apertures 222, which receive one or more fasteners 270. The fastener(s) 270 can engage with the tool 100, thereby securing the indexing member 220 with respect to the tool 100. The fasteners 270 can be bolts, screws, or other types of fasteners. The indexing member 220 could be secured to the tool 100 via other means, such as a clip, a spring-activated connector, or the like. When the indexing member 220 is secured to the tool 100, the shoe 210 moves with respect to the tool 100 in a predictable manner. It will be understood that even though the indexing member 220 could be secured to the tool 100, the indexing member 220 can still move with respect to the shoe 210.

According to certain embodiments, the indexing member 220 includes a plurality of elevated portions 223 that are separated by a plurality of index openings 224. The elevated portions 223 extend upwardly from the base region 221. As shown, there are four elevated portions 223 separated by three index openings 224, although different numbers are possible. The number of index openings 224 determine the number of predetermined positions that the shoe 210 can be locked into (with respect to the indexing member 220). So, for example, if the indexing member 220 has four index openings 224, there are four different predetermined positions for the shoe 210. The elevated portions 223 and/or index openings 224 can be located proximate to or at a lateral edge of the indexing member 220 (as shown). The elevated portions 223 and index openings 224 could also be located inwardly from the lateral edge of the indexing member 220. The elevated portions 223 can be elongated (as shown) or have another shape. The index openings 224 are wide enough to accept a part of the index plunger 230, as further described. The indexing member 220 can include at least one feature 225 that constrains a movement of the index plunger 230, as further described. As shown, such a feature 225 can be a ridge located inwardly from a lateral edge of the indexing member 220 that prevents further inward movement of the index plunger 230. The indexing member 220 can include or be formed of a material such as steel, aluminum, or other suitable metals. The index plunger 230 includes a transverse portion 231 having a region proximate to the actuator 240 and a region distal from the actuator 240. The index plunger 230 further includes an engagement portion 232. The engagement portion 232 extends downwardly from the distal region of the transverse portion 231. The engagement portion 232 could alternatively extend horizontally or at a different angle from the transverse portion 231. The transverse portion 231 can extend horizontally from the proximate region to the distal region along an axial dimension 20. The transverse portion 231 can be substantially straight or could include curved or angled contours along its length. The index plunger 230 can be coupled to the shoe 210, for example, via the coupler 260. The index plunger 230 and the shoe 210 can be coupled such that a movement of the shoe 210 causes a corresponding movement of the index plunger 230. The index plunger 230 can include or be formed of a material such as steel, aluminum, or other suitable metals. The index plunger 230, as depicted, forms an “L” shape. Other shapes may be possible, such as a rounded hook.

The index plunger 230 may move along an axial dimension 20 (for example, a dimension 20 corresponding to an axis defined by the transverse portion 231). The axial dimension 20 can be orthogonal to the longitudinal dimension along which the indexing member 220 moves. When the index plunger 230 is in a first position, the engagement portion 232 (or a portion thereof) is received by a given index opening 224. When the engagement portion 232 is received by the given index opening 224, the position of the shoe 210 is substantially locked with respect to the indexing member 220. For example, the shoe 210 cannot substantially move along the longitudinal dimension 10 of the indexing member 220 when locked. When the index plunger 230 is in a second position, the engagement portion 232 is not received by an index opening 224, and the shoe 210 is moveable with respect to the indexing member 220 (e.g., moveable along the longitudinal dimension 10).

The actuator 240 is configured to receive an engagement force. Such an engagement force can come from an operator, such as from an operator's finger. The actuator 240 transfers the received engagement force directly or indirectly to the index plunger 230. For example, the actuator 240 can form a cap on a portion of the index plunger 230 (e.g., the proximate region of the index plunger 230), and can directly contact the index plunger 230. Such a cap could include a recess that receives a portion of the index plunger 230. When the actuator 240 directly contacts the index plunger 230, the engagement force received at the actuator 240 is directly transferred to the index plunger 230. The engagement force can include a directional component along the axial dimension 20. The actuator 240 need not directly contact the index plunger 230. For example, the actuator 240 could transfer the engagement force to the index plunger 230 via a system of levers, gears, or the like. The actuator 240 has an exterior surface suitably sized to receive a finger pad (for example, an index finger pad). The engagement force causes the index plunger 230 to move from the first position (shoe 210 is locked) to the second position (shoe 210 is moveable). According to some embodiments, the actuator 240 is integral or formed together with the index plunger 230.

The spring 250 can be a coil spring. The spring 250 can surround a portion of the index plunger 230 (e.g., a portion of the transverse portion 231). For example, the spring 250 and the transverse portion 231 could be substantially coaxial. The spring 250 can be configured to return the index plunger 230 to the first position when the engagement force is removed. For example, when the index plunger 230 receives the engagement force, the spring 250 also receives at least a portion of the engagement force, thereby causing the spring 250 to compress when the index plunger 230 is moved into the second position. When the engagement force is removed, the spring 250 returns to its equilibrium state, thereby forcing the index plunger 230 to return to the first position. A proximal end of the spring 250 can engage with or press against the actuator 240. A distal end of the spring 250 can engage with or press against a coupler 260. When the engagement force is applied to the actuator 240 and the index plunger 230 moves to the second position, the spring 250 can compress between the actuator 240 and the coupler 260. When the engagement force is removed, the spring 250 returns to its equilibrium length, thereby expanding the distance between the actuator 240 and the coupler 260 and placing the index plunger 230 in the first position.

The coupler 260 can couple the index plunger 230 to the indexing member 220. The coupler 260 can include a casing 261. At least a portion of the index plunger 230 and/or spring 250 can be housed within the casing 261. The casing 261 can be mounted to the shoe 210, for example, by one or more fasteners such as screws or bolts. The casing 261 could alternatively be integrated with the shoe 210. The casing 261 (either by itself or in together with the shoe 210) can include a through hole. The through hole can be substantially oriented along the axial dimension 20 of the index plunger 230. At least a portion of the index plunger 230 can be positioned in the through hole. The spring 250 can abut or engage with a portion of the casing 261 and/or the shoe 210. When the index plunger 230 is in the first position, the engagement portion 232 can be positioned within at least a portion of the casing 261. When the index plunger 230 is in the second position, the engagement portion 232 may jut out of the through hole of the casing 261 towards the indexing member 220. On the other side of the through hole, the actuator 240 can project out of the casing 261 such that an operator can apply an engagement force to the actuator 240. Alternatively, the actuator 240 may not project out of the casing 261, but the operator may still be able to access the actuator 240 and apply the engagement force.

When the actuator 240 receives the engagement force, the index plunger 230 moves inwardly to the second position. When that occurs, the spring 250 becomes compressed between the casing 261 and the actuator 240. When the engagement force is removed, the spring 250 decompresses and returns to its state of equilibrium. This causes the actuator 240 and index plunger 230 to move outwardly and return to the first position. The coupler 260 can prevent the index plunger 230 and/or actuator 240 from being pushed too far inwardly by the engagement force. For example, the width or radius of the through hole in the casing 261 proximate the proximal region of the index plunger 230 could be larger than the width or radius of the through hole of the casing 261 proximate the distal region of the index plunger 230. For example, the actuator 240 could fit inside of the proximal inlet of the through hole, but it may not fit inside the distal outlet of the through hole. Consequently, in this embodiment, the index plunger 230 can be prevented from being moved to a position past the second position (a position where the index plunger 230 extends farther inwardly over the indexing member 220). Furthermore, as discussed, the indexing member 220 could include a feature 225 that prevents the index plunger 230 from extending past the second position. As shown in FIG. 2C, the feature 225 could be a ridge extending along the longitudinal dimension 10. The feature 225 can prevent the engagement portion 232 of the index plunger 230 from extending inwardly past the second position.

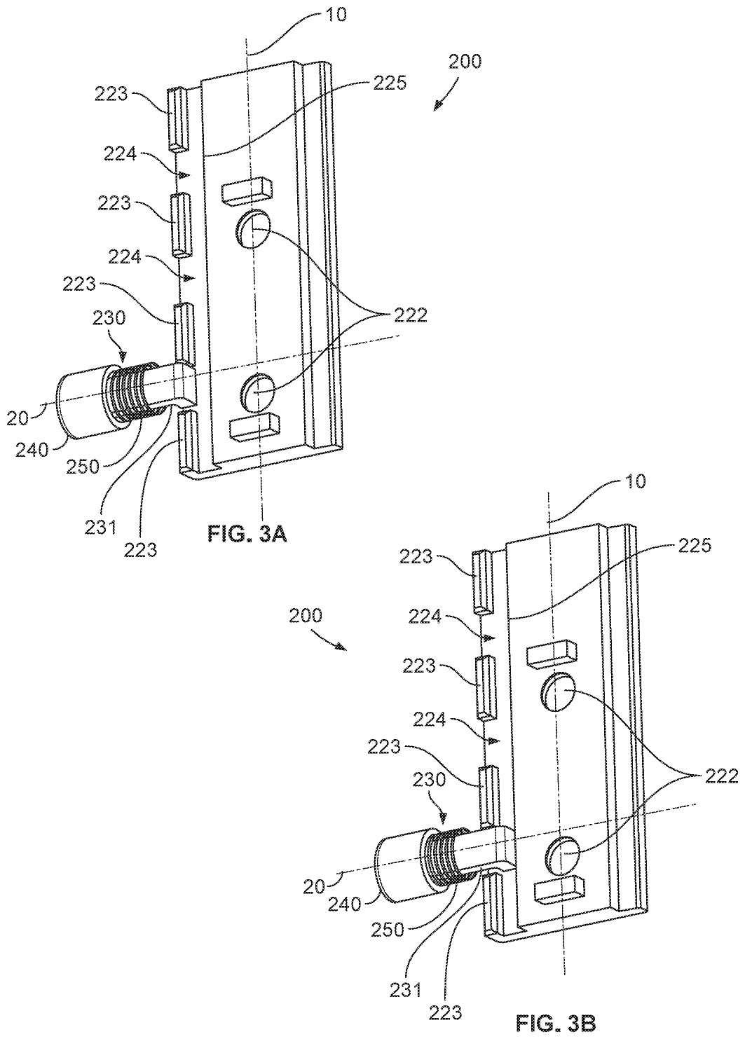

FIGS. 3A and 3B illustrate a portion of an adjustable shoe system 200 in a locked and unlocked arrangement, according to embodiments of the present invention. FIG. 3A shows the adjustable shoe system 200 in a locked arrangement. Specifically, when the index plunger 230 is in the first position, the engagement portion 232 is positioned in an index opening 224 of the indexing member 220. When a force is applied to the indexing member 220 or the index plunger 230 along the longitudinal dimension, the engagement portion 232 abuts one of the elevated portions 223, and substantial movement of either the indexing member 220 or index plunger 230 along the longitudinal dimension 10 is prevented. FIG. 3B shows the adjustable shoe system 200 in an unlocked arrangement. When the index plunger 230 is moved into the second position, the engagement portion 232 is no longer positioned in the index opening 224, and longitudinal movement of either the index plunger 230 or the indexing member 220 is permitted.

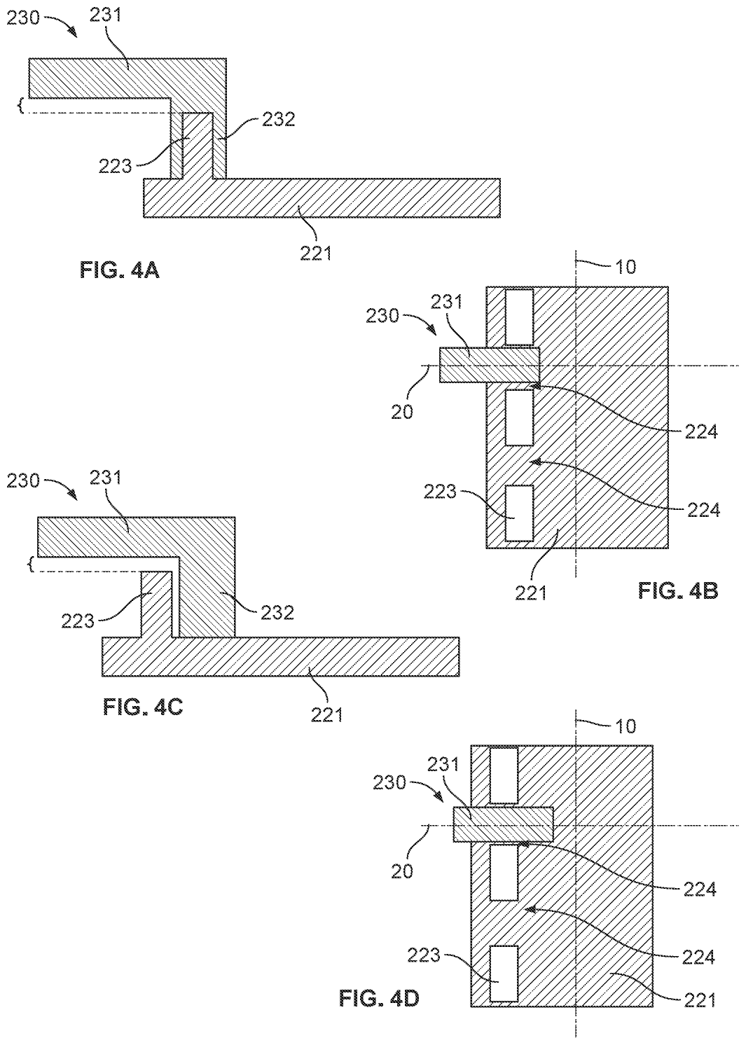

FIGS. 4A, 4B, 4C, and 4D show representational depictions of operations of the adjustable shoe system 200, according to techniques of the present application. FIG. 4A illustrates a representational cross-sectional view of the index plunger 230 and the indexing member 220 in the first (locked) position. FIG. 4B illustrates a top view of the index plunger 230 and the indexing member 220 in the first position. FIG. 4C illustrates a representational cross-sectional view of the index plunger 230 and the indexing member 220 in the second (unlocked) position. FIG. 4D illustrates a top view of the index plunger 230 and the indexing member 220 in the second position.

As shown in FIGS. 4A and 4B, the engagement portion 232 of the index plunger 230 is located in an index opening 224 between two elevated portions 223. As discussed, this prevents longitudinal movement of either the index plunger 230 or the indexing member 220. As shown in FIGS. 4C and 4D, the engagement portion 232 of the index plunger 230 is located outside of this index opening 224 (specifically, farther inward). In this arrangement, when a force along the longitudinal dimension 10 is applied to either the index plunger 230 or the indexing member 220, no portion of the index plunger 230 engages with, abuts, or interacts with the elevated portions 223. For example, the transverse portion 231 does not engage, abut, or interact with the elevated portion 223 when the index plunger 230 is in the second position.

As shown in FIGS. 4A and 4C, the elevated portions 223 have a maximum elevation above the base region 221 of the indexing member 220. The transverse portion 231 has a minimum elevation that is higher than the maximum elevation of the elevated portions 223. This creates a gap indicated by a bracket (“{”) in FIGS. 4A and 4C. According to this design, when a force along the longitudinal dimension is applied to either the indexing member 220 or the index plunger 230, the transverse portion 231 passes over the elevated portions 223 without obstruction because of the gap. Furthermore, the engagement portion 232 of the index plunger 230 also has an unobstructed path to move along the longitudinal dimension 10 over the base region 221 of the indexing member 220. Without obstruction, the index plunger 230 or the indexing member 220 are also movable along the longitudinal dimension 10. Furthermore, when the shoe 210 is coupled to the index plunger 230, movement of the shoe 210 follows movement of the index plunger 230 and vice versa. In this manner, longitudinal movement of the shoe 210 can be prevented or enabled based on the position of the index plunger 230 with respect to the indexing member 220.

In addition to the positioning of the shoe 210 discussed above, it can also be possible to move the position of the indexing member 220 with respect to the housing 110, thereby allowing the shoe 210 to be placed in any number of additional positions according to design preferences. The indexing member 220 can be repositionable with respect to the housing 110. For example, fasteners 270 (e.g., bolts) could engage with nuts (not shown) that are embedded in the housing 110. Even though such nuts are be embedded in the housing 110, the nuts could still be movable (e.g., movable continuously) with respect to the housing 110. The operator could adjust the position of the nuts, and after the nuts have been positioned in a desired location with respect to the housing 110, the operator can secure the fasteners 270 to the nuts. As another option, the housing 110 could include a plurality of threaded holes that receive the fasteners 270 such that the indexing member 220 could be mounted at different locations with respect to the housing 110.

Once the system 200 is mounted to the housing 110, the shoe 210 can be prevented from becoming disengaged from the indexing member 220. For example, a portion of the housing 110 can limit the movement of the shoe 210, such that it cannot move past a position in which it is engaged with the indexing member 220. Under such a configuration, the only way to remove the shoe 210 from the system 200 might be to unfasten and remove the indexing member 220 from the housing 110. When the indexing member 220 is unfastened, the entire system 200 can be moved such that the shoe 210 can be disengaged from the indexing member 220. Alternatively, when the indexing member 220 is unfastened from the housing 110, the indexing member 220 could be able to slide off of the shoe 210, thereby disengaging the shoe 210 from the indexing member 220 and allowing the shoe 210 to be separated from the system 200.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A shoe positioning system for use with a power tool that operates on a work piece, the shoe positioning system comprising:
a shoe configured to abut the work piece;
an indexing member movably engaged with the shoe, wherein the indexing member includes a plurality of elevated portions separating a plurality of index openings;
an index plunger coupled to the shoe, wherein the index plunger is configured to receive an engagement force to move the index plunger in a first direction along its axial axis, and wherein the index plunger includes an engagement portion; and
wherein:
when the engagement force is not received by the index plunger, the engagement portion is configured to be disposed in a first position;
when the engagement force is received by the index plunger, the engagement portion is configured to move to a second position;
when the index plunger is in the first position, the engagement portion of the index plunger is received by at least one of the index openings, thereby preventing the shoe from substantially moving along a longitudinal dimension with respect to the indexing member; and
when the index plunger is in the second position, the engagement portion of the index plunger is outside of the index openings, thereby permitting the shoe to move along the longitudinal dimension with respect to the indexing member.

2. The shoe positioning system of claim 1, further comprising a spring configured to bias the index plunger in a second direction opposite the first direction along the axial axis of the index plunger.

3. The shoe positioning system of claim 2, wherein the spring substantially surrounds an axial portion of the index plunger.

4. The shoe positioning system of claim 2, wherein:
the spring is configured to maintain the index plunger in the first position when the engagement force is not received by the index plunger; and
the spring is configured to return the index plunger to the first position when the index plunger is in the second position and the engagement force is removed from the index plunger.

5. The shoe positioning system of claim 1, wherein the axial axis of the index plunger and the longitudinal dimension are substantially orthogonal.

6. The shoe positioning system of claim 1, wherein two or more of the index openings are spaced apart from each other along the longitudinal dimension.

7. The shoe positioning system of claim 1, wherein the shoe includes a slot configured to receive the indexing member.

8. The shoe positioning system of claim 1, wherein the indexing member is configured to be mounted to the power tool.

9. The shoe positioning system of claim 1, wherein the indexing member further comprises at least one feature configured to constrain a range of movement of the shoe along the longitudinal dimension.

10. The shoe positioning system of claim 1, wherein the indexing member further comprises at least one feature configured to constrain a range of movement of the index plunger along its axial axis.

11. A shoe positioning system for use with a power tool that operates on a work piece, the shoe positioning system comprising:
a shoe configured to abut the work piece;
an indexing member including a base region and a plurality of elevated portions extending upwardly to a maximum elevation above the base region, wherein the plurality of elevated portions are separated by a plurality of index openings that do not extend upwardly to the maximum elevation above the base region;
an index plunger coupled to the shoe, wherein the index plunger includes a transverse portion having a lowest elevation that is maintained at an elevation above the elevated portions of the indexing member, and wherein the index plunger includes an engagement portion extending downwardly from the transverse portion towards the base region of the indexing member; and
wherein:
the shoe is configured to move along a longitudinal dimension with respect to the indexing member;
the index plunger is configured to move along its axial axis, wherein the index plunger is movable to a first position and a second position with respect to the indexing member;
when the index plunger is in the first position, at least a portion of the engagement portion is positioned in one of the index openings of the indexing member, thereby preventing substantial movement of the shoe along its longitudinal dimension with respect to the indexing member; and
when the index plunger is in the second position, the at least a portion of the engagement portion is positioned outside the index openings of the indexing member, thereby permitting movement of the shoe with respect to the indexing member along its longitudinal dimension, such that at least a portion of at least one elevated portion passes under the transverse portion of the index plunger as the shoe moves.

12. The shoe positioning system of claim 11, further comprising a spring configured to bias the index plunger towards the first position.

13. The shoe positioning system of claim 12, wherein the spring substantially surrounds a portion of the index plunger.

14. The shoe positioning system of claim 12, wherein:
the spring is configured to maintain the index plunger in the first position when the engagement force is not received by the index plunger; and
the spring is configured to return the index plunger to the first position when the index plunger is in the second position and the engagement force is removed from the index plunger.

15. The shoe positioning system of claim 11, wherein the axial axis of the index plunger and the longitudinal dimension are substantially orthogonal.

16. The shoe positioning system of claim 11, wherein two or more of the index openings are spaced apart from each other along the longitudinal dimension.

17. The shoe positioning system of claim 11, wherein the shoe includes a slot configured to receive the indexing member.

18. The shoe positioning system of claim 11, wherein the indexing member is configured to be mounted to the power tool.

19. The shoe positioning system of claim 11, wherein the indexing member further comprises at least one feature configured to constrain a range of movement of the shoe along the longitudinal dimension.

20. The shoe positioning system of claim 11, wherein the indexing member further comprises at least one feature configured to constrain a range of movement of the index plunger along its axial axis.
